(19) United States
(12) Patent Application Publication
(10) Pub. No.: US 2008/0070080 A1
(43) Pub. Date: Mar. 20, 2008

(54) Fuel Cell Separator

(75) Inventor: Shinichi Miyazaki, Kanagawa (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/719,057

(22) PCT Filed: Nov. 22, 2005
(86) PCT No.: PCT/JP05/21929

§ 371 Date: May 10, 2007

(30) Foreign Application Priority Data
Dec. 16, 2004 (JP) 2004-364335

(51) Int. Cl. H01M 2/14; H01M 8/00

(52) U.S. Cl. 429/26; 429/34

(57) ABSTRACT

A fluid passage (8) in a separator (1) is formed with a greater width than an inlet manifold (2) and an outlet manifold (5), and is constituted by: a main passage portion (11) comprising a first rib (21) which divides the main passage portion (11) into a plurality of passages; and a distribution portion (10) and a merging portion (12) disposed between the main passage portion (11) and the inlet manifold (2) or outlet manifold (5), comprising a second rib (20, 22) which divides the distribution portion (10) and merging portion (12) into a plurality of passages, and a gap (13, 14) provided between the end portion of the second rib (20, 22) and the first rib (21) of the main passage (11) for the purpose of re-distribution or re-merging. At least one of the first and second ribs (20, 21, 22) exists in at least one of the location in a length direction position of the separator (1) in which the gap (13, 14) for re-distribution or re-merging exists.

### FIELD OF THE INVENTION

This invention relates to a fuel cell separator which supports an electrolyte membrane from both sides via catalyst electrodes to form a polymer electrolyte fuel cell.

### BACKGROUND OF THE INVENTION

To provide an even current density while preventing water retention, the surface of a separator which supplies fuel and oxidant gas to the entire surface of an electrode catalyst portion is typically provided with a plurality of straight passages or serpentine passages.

When the width of the main passage is greater than the width of reactant gas intake/exhaust manifolds, a distribution portion and a merging portion are provided between the intake/exhaust manifolds and the main passage to vary the passage width, as disclosed in JP2003-323905A, published by the Japan Patent Office, and a plurality of upright protrusions is provided in the distribution portion and merging portion so that the reactant gas is distributed and merged evenly.

### SUMMARY OF THE INVENTION

When a plurality of upright protrusions is provided in the distribution portion and merging portion, it is effective to provide breaks in the protrusions to promote the re-distribution and re-merging of the reactant gas. Breaks are provided similarly in the protrusions in JP2003-323905A for the purpose of re-distribution and re-merging. However, the strength of the separator decreases in regions having no protrusions.

It is therefore an object of the present invention to secure the strength of a fuel cell separator while maintaining reactant gas re-distribution and re-merging functions.

In order to achieve the above-mentioned object, this invention provides a fuel cell separator which supports an electrolyte membrane from either side via an electrode catalyst to form a polymer electrolyte fuel cell, comprising on a front surface thereof a fluid passage (gas passage or cooling medium passage) which supplies a fluid (oxidant gas, fuel gas or cooling medium) to a surface of the electrolyte membrane. The fluid passage of the separator comprises: a main passage portion having a greater width than an inlet manifold and an outlet manifold, and comprising a first rib which divides the main passage portion into a plurality of passages; and a distribution portion and a merging portion disposed between the main passage portion and the inlet manifold or outlet manifold, comprising a second rib which divides the distribution portion and merging portion into a plurality of passages, and a gap provided between an end portion of the second rib and the first rib for the purpose of re-distribution or re-merging, and either at least one of the first and second ribs exists in at least one location in a length direction position of the separator in which the gap exists, or a third rib for dividing a fluid passage formed on a rear surface of the separator exists in at least one location in the length direction position of the separator in which the gap exists.

The details as well as other features and advantages of this invention are set forth in the remainder of the specification and are shown in the accompanying drawings.

### BRIEF DESCRIPTION OF THE DRAWINGS

FIG. 1 is a front view of a fuel cell separator according to a first embodiment of this invention.

FIG. 2 is a sectional view along a line II-II in FIG. 1.

FIGS. 3A and 3B are views showing gas passages in a fuel cell separator according to a second embodiment of this invention, FIG. 3A showing a front surface side, and FIG. 3B showing a rear surface side.

FIG. 4 is a sectional view along a line IV-IV in FIG. 3A.

FIGS. 5A and 5B are views showing gas passages in a fuel cell separator according to a third embodiment of this invention, FIG. 5A showing a front surface side, and FIG. 5B showing a rear surface side.

FIGS. 6A and 6B are views showing gas passages in a fuel cell separator according to a fourth embodiment of this invention, FIG. 6A showing a front surface side, and FIG. 6B showing a rear surface side.

FIGS. 7A and 7B are views showing gas passages in a fuel cell separator according to a fifth embodiment of this invention, FIG. 7A showing a front surface side, and FIG. 7B showing a rear surface side.

FIGS. 8A and 8B are views showing gas passages in a fuel cell separator according to a sixth embodiment of this invention, FIG. 8A showing a front surface side, and FIG. 8B showing a rear surface side.

FIGS. 9A and 9B are views showing gas passages in a fuel cell separator according to a seventh embodiment of this invention, FIG. 9A showing a front surface side, and FIG. 9B showing a rear surface side.

### DESCRIPTION OF THE PREFERRED EMBODIMENTS

### First Embodiment

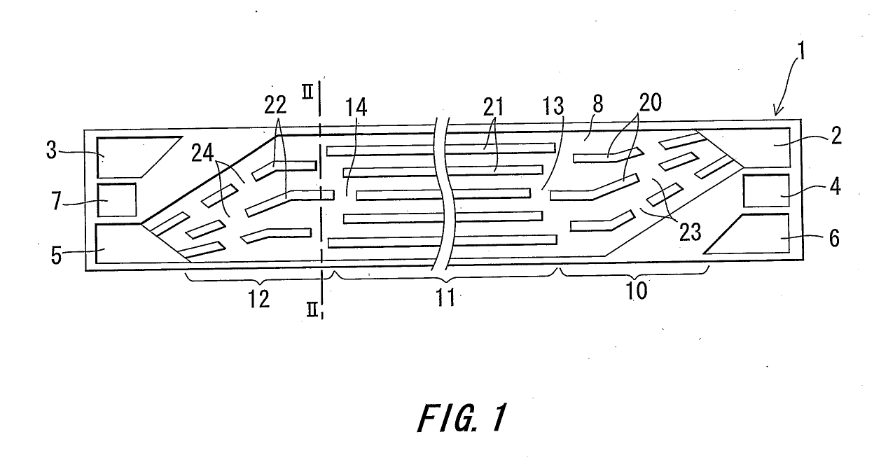

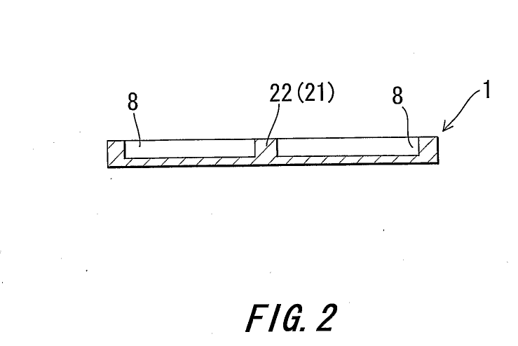

FIGS. 1 and 2 show a first embodiment of a fuel cell separator to which this invention is applied. FIG. 1 is a front view of the fuel cell separator, and FIG. 2 is a sectional view along a line II-II in FIG. 1.

Although not shown in the drawing, in a typical polymer electrolyte fuel cell, a single fuel cell is constituted by a membrane electrode assembly supported on either side by a separator comprising a fuel gas passage which supplies a fuel gas such as hydrogen to one electrode catalyst of the membrane electrode assembly, and a separator comprising an oxidant gas passage which supplies an oxidant gas such as air to another electrode catalyst of the membrane electrode assembly, and a fuel cell stack is constituted by stacking together a predetermined number of these single cells and fastening them in the stacking direction using an end plate. The separator adjacent to the end plate of the fuel cell stack is formed with a gas supply passage on only one surface. Further, the separators that have membrane electrode assemblies on both sides, i.e. the separators positioned in the parts that are sandwiched between membrane electrode assemblies, are formed with gas supply passages on both surfaces. Also, the separator adjacent to the separator comprising on its back surface a passage through which a cooling medium flows is formed with a gas supply passage on only the side surface which faces the membrane electrode assembly.

As shown in FIG. 1, to supply and discharge the fuel gas, oxidant gas, and cooling medium to and from the fuel cell, inlet manifolds 2-4 which supply the gases and cooling medium are formed on one peripheral edge side of a separator 1 and the membrane electrode assembly constituting the fuel cell, and outlet manifolds 5-7 which discharge the gases and cooling medium liquid employed in the reaction are formed on the other peripheral edge side thereof.

A gas passage 8 serves to supply the electrode catalyst of the membrane electrode assembly with a fuel gas such as hydrogen, for example. The inlet manifold 2 and outlet manifold 5 are disposed alongside the other gas manifolds 3, 6 and the cooling manifold 7, and therefore the width of the inlet manifold 2 and outlet manifold 5 is smaller than the passage width of a main passage portion 11. Accordingly, a distribution portion 10 and a merging portion 12 connecting the manifolds 2, 5 to the main passage portion 11 have a passage width that increases gradually from the manifolds 2, 5 toward the main passage portion 11.

It should be noted that in both a fuel cell stack comprising the inlet manifolds or outlet manifolds on the exterior of the fuel cell stack, and a fuel cell stack in which either the inlet manifolds or outlet manifolds are disposed so as to pass through the fuel cell stack and the other manifolds are disposed on the exterior of the fuel cell stack, the width of the inlet passage and outlet passage which connect the manifolds to the gas passage or cooling medium passage inside the fuel cell stack is narrower than the main gas passage width or main cooling medium passage width in the fuel cell stack, and a distribution portion and merging portion are formed therebetween.

The main passage portion 11 is divided along the passage by a plurality of ribs 21. The fuel gas or oxidant gas flows along these divided passages, and is thus supplied evenly to the electrode catalyst surface of the membrane electrode assembly covering the passages. The ribs 21 positioned in the central portion of the main passage 11 are short, and the length of the ribs 21 increases gradually away from the central portion of the main passage portion 11 toward the edges. Hence the end portions of the ribs 21 protrude in the separator length direction at the two edges of the main passage portion 11, and recede in the separator length direction in the center of the main passage portion 11.

The distribution portion 10 and merging portion 12 are divided by a plurality of ribs 20, 22 along the passage, and each rib 20, 22 is divided into a plurality midway in the length direction thereof by dividing portions 23, 24. The dividing portion 23, 24 of each rib 20, 22 is offset from the dividing portion 23, 24 of the adjacent rib 20, 22 in the separator length direction so that no dividing portions 23, 24 are provided in identical positions in the separator length direction.

A part of each rib 20, 22 on the main passage 11 side is bent in accordance with the deflection of the distribution portion 10 and merging portion 12 toward the main passage 11 so as to be parallel to the ribs 21 disposed in the main passage 11. The ribs 20, 22 at the two edges of the passage have short end portions, and the ribs 20, 22 in the center of the passage have long end portions which protrude toward the main passage side. These respective end portions face the end portions of the ribs 21 disposed in the main passage 11 with a gap having a preset dimension therebetween. In other words, gaps 13, 14 for promoting the re-distribution and re-merging of the reactant gas are provided between the end portion of the ribs 21 in the main passage 11 and the end portion of the ribs 20, 22 in the distribution portion 10 and merging portion 12. The gaps 13, 14 are arranged in an arc form which curves toward the main passage 11 side in the center.

As described above, the gaps 13, 14 formed between the end portion of the ribs 21 disposed in the main passage 11 and the end portion of the ribs 20, 22 disposed in the distribution portion 10 and/or merging portion 12 are disposed to be offset from their adjacent gaps 13, 14 in the length direction of the separator 1. As a result, the ribs 20, 22, or 21 exist in at least one location in any cross-section perpendicular to the length direction of the separator 1, for example the II-II cross-section shown in FIG. 2.

Hence at least one rib 20, 22, or 21 which is resistant to bending exists in any cross-section perpendicular to the length direction of the separator 1, and thus the strength of the separator 1 can be improved.

In FIG. 1, the end portions of the plurality of ribs 20, 22 disposed in the distribution portion 10 and merging portion 12 protrude in the separator length direction in the center of the passage, and the end portions of the plurality of ribs 21 disposed in the main passage portion 11 recede in the separator length direction in the center of the passage. However, a constitution is possible whereby the end portions of the plurality of ribs 20, 22 disposed in the distribution portion 10 and merging portion 12 recede in the separator length direction in the center of the passage, and the end portions of the plurality of ribs 21 disposed in the main passage portion 11 protrude in the separator length direction in the center of the passage.

Furthermore, the gaps 13, 14 formed between the end portion of the ribs 21 disposed in the main passage portion 11 and the end portion of the ribs 20, 22 disposed in the distribution portion 10 and merging portion 12 may be disposed to be gradually, alternately, or randomly offset from their adjacent gaps 13, 14 in the length direction of the separator 1.

Here, the passage 8 was described as a passage for supplying a fuel gas such as hydrogen to the electrode catalyst of the membrane electrode assembly, but the passage 8 may be a gas passage for supplying an oxidant gas such as oxygen (air) to the electrode catalyst of the membrane electrode assembly, or a cooling medium passage through which a cooling medium flows, for example. The ribs 20, 22 do not necessarily have to extend into the length direction positions of the separator 1 in which the gaps 13, 14 for re-distribution or re-merging are formed, and the strength of the separator 1 may also be secured if a rib which divides a gas passage or cooling medium passage formed on the back surface portion thereof exists in at least one location in these positions.

Moreover, the separator 1 shown in FIG. 1 comprises the gas passage 8 on one surface, but the separator 1 may be a fuel cell separator comprising gas passages on both surfaces, or a fuel cell separator comprising a gas passage on one surface and a cooling medium passage on the other surface, for example.

Here, the inlet manifolds 2-4 for supplying gas and liquid are formed on one of the peripheral edge sides of the separator 1 and membrane electrode assembly constituting the fuel cell, and the outlet manifolds 5-7 are formed on the other peripheral edge side. However, the inlet manifolds or outlet manifolds may be provided on the exterior of the fuel cell stack. Alternatively, either the inlet manifolds or outlet manifolds may be disposed so as to pass through the fuel cell stack, and the other manifolds may be disposed on the exterior of the fuel cell stack. In all cases, the width of the inlet passage and outlet passage which connect the manifolds to the gas passage or cooling medium passage inside the fuel cell stack is narrower than the main passage width of the gas passage or the main passage width of the cooling medium passage in the fuel cell stack, and a distribution portion and merging portion are formed therebetween.

In this embodiment, the effects listed below can be achieved.

(a) At least one of the ribs 20-22 for dividing the main passage portion 11 or the distribution portion 10 or merging portion 12 exists in at least one location in the length direction position of the separator 1 in which the gaps 13, 14 for re-distribution or re-merging exist. Alternatively, a rib for dividing a gas passage or cooling medium passage formed on the back surface portion exists in at least one location in these positions. Hence, at least one rib which is resistant to bending exists in any cross-section which intersects the length direction of the separator 1, and thus the strength of the separator 1 can be improved.

(b) The gaps 13, 14 for re-distribution or re-merging are disposed to be either gradually or alternately offset from the gap between the adjacent ribs in the length direction of the separator 1. Hence, at least one rib which is resistant to bending exists in any cross-section which intersects the length direction of the separator 1, and thus the strength of the separator 1 can be improved.

(c) The passages of the distribution portion 10 and/or merging portion 12 disposed on at least one surface of the separator 1 are straight passages divided by the ribs 20, 22. Since the passage direction length of the straight passages is great and the number of passages is small, pressure loss in the fluids flowing through the passages is large. As a result, distribution to the main passage 11 and merging from the main passage 11 can be performed more evenly.

### Second through Fourth Embodiments

The second through fourth embodiments have common features, and will therefore be described together.

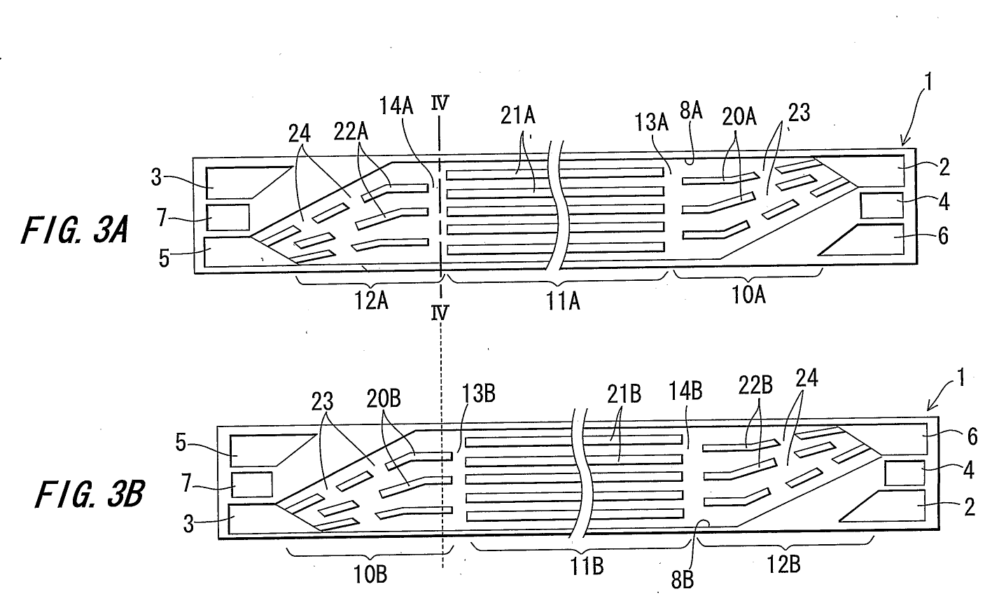

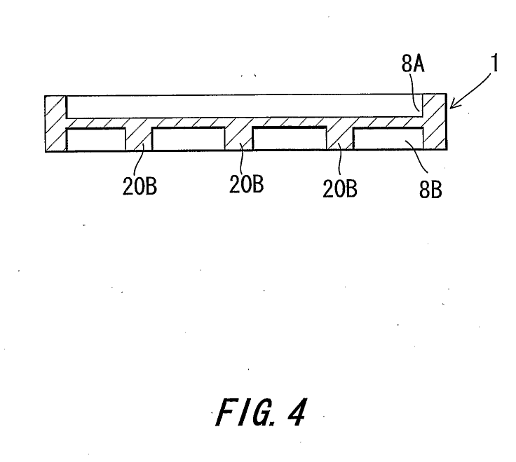

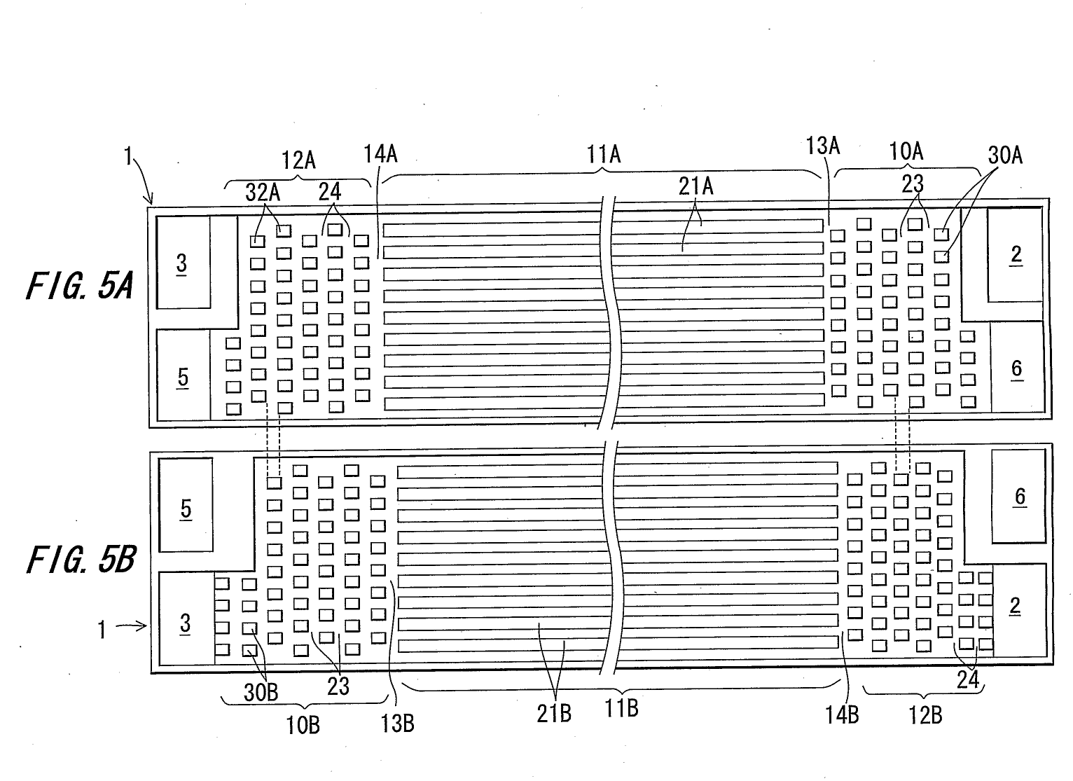

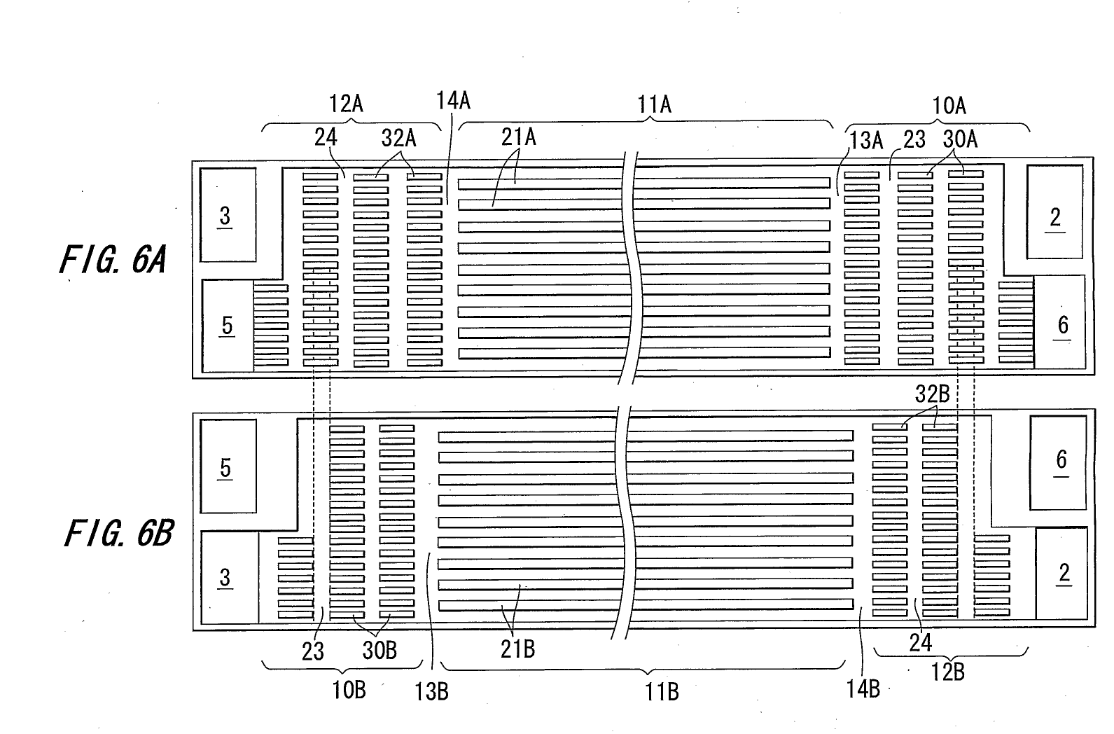

FIGS. 3A and 3B are views showing gas passages on the front surface side and rear surface side of a fuel cell separator according to the second embodiment, FIG. 4 is a sectional view along a line IV-IV in FIG. 3A, FIGS. 5A and 5B are views showing gas passages on the front surface side and rear surface side of a fuel cell separator according to the third embodiment, and FIGS. 6A and 6B are views showing gas passages on the front surface side and rear surface side of a fuel cell separator according to the fourth embodiment.

In these embodiments, the gaps between the ribs in the distribution portion and/or merging portion, and/or the gaps between the ribs constituting the distribution portion and/or merging portion and the ribs constituting the main passage portion, are offset between the front surface side and rear surface side. Identical constitutional elements to those shown in FIG. 1 have been allocated identical reference numerals, and description thereof has been omitted for the sake of simplicity.

In the separator 1 of the second embodiment shown in FIGS. 3A and 3B, a flat separator 1 comprising gas passages 8A, 8B on both surfaces is provided, and ribs 21A, 21B constituting main passages 11A, 11B are disposed on each surface and have an identical length so as to be aligned in length direction positions. The disposal positions of the ribs 21A, 21B constituting the main passages 11A, 11B are offset between the front surface side and rear surface side in the separator length direction such that the ribs 21A are biased toward a merging portion 12A side and the ribs 21B are biased toward a merging portion 12B side. Accordingly, the respective end portions of the ribs 21A, 21B are offset between the front surface side and rear surface side.

Similarly to the first embodiment, the distribution portion 10 and merging portion 12 are divided along the passage 8 by a plurality of ribs 20A, 20B and 22A, 22B, respectively, and each rib 20A, 20B, 22A, 22B is divided midway into a plurality in the length direction thereof by the dividing portions 23, 24. Also similarly to the first embodiment, the dividing portion 23, 24 of each rib 20A, 20B, 22A, 22B is offset from the dividing portion 23, 24 of the adjacent rib 20A, 20B, 22A, 22B in the length direction of the separator 1 so that no dividing portions 23, 24 are provided in identical positions in the length direction of the separator 1.

A part of each rib 20A, 20B, 22A, 22B on the main passage 11 side is bent in accordance with the deflection of the distribution portions 10A, 10B and merging portions 12A, 12B toward the main passages 11A, 11B so as to be parallel to the ribs 21A, 21B disposed in the main passages 11A, 11B. The end portions of the ribs 20A, 20B, 22A, 22B are aligned in the length direction of the separator 1, and arranged to face the end portions of the ribs 21A, 21B disposed in the main passages 11A, 11B with gaps 13A, 13B, 14A, 14B having a preset dimension therebetween.

In the separator 1 of the second embodiment, constituted as described above, the positions in the separator length direction of the gaps 13A, 13B, 14A, 14B formed between the ribs 20A, 20B, 22A, 22B constituting the distribution portions 10A, 10B and merging portions 12A, 12B and the ribs 21A, 21B constituting the main passages 11A, 11B are offset between the front surface side (13A, 14A) and rear surface side (13B, 14B) of the separator 1. As a result, at least one rib (the rib 20B in FIG. 4) exists on at least one surface in any cross-section perpendicular to the length direction of the separator 1, as shown in the cross-section along the line IV-IV (FIG. 4).

Hence at least one rib which is resistant to bending exists in any cross-section which intersects the length direction of the separator 1, and thus the strength of the separator 1 can be improved.

In the separator of the third embodiment shown in FIGS. 5A, 5B, the ribs 21 constituting the main passage 11 are similar to the second embodiment, but the ribs of the distribution portion 10 and merging portion 12 are formed by divided ribs 30, 32 taking rectangular shapes. By forming the distribution portion 10 and merging portion 12 using these rectangular divided ribs 30, 32, the distribution function of the gas that is supplied through the inlet manifolds 2, 3 and the merging function of the gas that is discharged into the outlet manifolds 5, 6 are improved even further.

In the distribution portion 10 and merging portion 12 of this separator 1, the positions in the separator length direction of the gaps 23, 24 between the divided ribs 30A, 30B, 32A, 32B do not overlap between the front surface side and rear surface side of the separator 1. In other words, the divided ribs 30A, 30B, 32A, 32B are disposed on the two surfaces such that the divided ribs 30A, 30B are disposed in positions on the rear surface side where the gaps 24 exist on the front surface side, and the gaps 23 exist in positions on the rear surface side where the divided ribs 32A, 32B are disposed on the front surface side. More specifically, the rectangular ribs 30A, 30B, 32A, 32B of the distribution portions 10A, 10B and merging portions 12A, 12B on both surfaces are disposed at an identical pitch to the length of one side thereof in the gas flow direction, and the rib positions on both surfaces are offset by one pitch in the gas flow direction.

In the separator 1 of the fourth embodiment shown in FIGS. 6A, 6B, the divided ribs 30A, 30B, 32A, 32B of the third embodiment shown in FIGS. 5A, 5B take a rectangular form that is long in the length direction of the separator 1. It should be noted, however, that the gaps 23, 24 between the rectangular divided ribs 30A, 30B, 32A, 32B are not increased in width, and have an identical dimension to the gaps 23, 24 between the divided ribs shown in FIGS. 5A, 5B. Hence, the divided ribs 30A, 30B exist in positions on the rear surface side where the gaps 24 exist on the front surface side, and the gaps 23 exist in positions on the rear surface side where a part of the divided ribs 32A, 32B exist on the front surface side. In other words, the gaps 23, 24 and the divided ribs 30A, 30B, 32A, 32B overlap on the front surface side and rear surface side, and as a result, the divided ribs 30A, 32A on the front surface side are offset from the divided ribs 30B, 32B on the rear surface side.

In the separators of the third and fourth embodiments described above, the positions in the separator length direction of the gaps 13A, 13B, 14A, 14B between the ribs 30A, 30B, 32A, 32B constituting the distribution portions 10A, 10B and merging portions 12A, 12B and the ribs 21A, 21B constituting the main passage portions 11A, 11B differ between the front surface side and rear surface side of the separator.

Thus a rib exists on at least one surface on any cross-section intersecting the length direction of the separator 1. Moreover, the divided ribs 30A, 30B, 32A, 32B disposed in the distribution portions 10A, 10B and merging portions 12A, 12B or the gaps 23, 24 between the divided ribs are offset between the front surface side and rear surface side. As a result, in the distribution portions 10A, 10B and merging portions 12A, 12B also, at least one rib exists on at least one surface in any cross-section that intersects the length direction of the separator 1.

Hence at least one rib which is resistant to bending exists in any cross-section that intersects the length direction of the separator 1, and thus the strength of the separator 1 can be improved.

In the second through fourth embodiments, the following effects can be achieved in addition to the effect (a) of the first embodiment.

(d) The gaps 13A, 14A for re-distribution or re-merging are offset in the length direction of the separator 1 from the gaps 13B, 14B provided in the gas passage or cooling medium passage disposed on the back surface for the purpose of re-distribution or re-merging. As a result, at least one rib which is resistant to bending exists in any cross-section that intersects the length direction of the separator 1, and thus the strength of the separator 1 can be improved.

(e) Of the passages 8A, 8B formed on the respective surfaces of the separator 1, the passages of the main passage portions 11A, 11B are parallel. Thus the ribs 21A, 21B which divide the main passage portions 11A, 11B are arranged in the length direction of the separator 1 on both surfaces of the separator 1, and therefore the flexural strength of the separator 1 in the length direction can be improved.

(f) As shown in FIGS. 5A, 5B and 6A, 6B, when the distribution portions 10A, 10B and/or the merging portions 12A, 12B are distributed and merged by the dividing ribs 30A, 30B, 32A, 32B, the positions in the separator width direction of the gaps 23, 24 between the ribs 30A, 30B, 32A, 32B constituting the distribution portions 10A, 10B and merging portions 12A, 12B differ between the front surface side and rear surface side of the separator 1. As a result, at least one rib exists on at least one surface in any cross-section perpendicular to the length direction of the separator 1, and thus the flexural strength of the separator 1 in the length direction can be improved.

### Fifth Embodiment

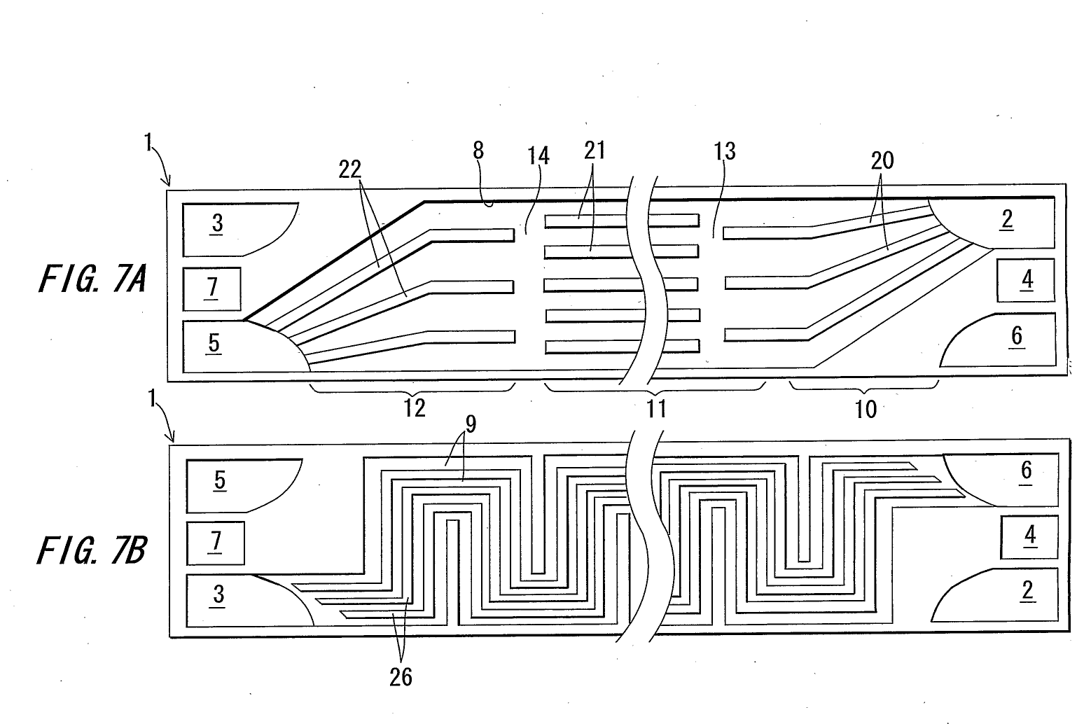

FIGS. 7A and 7B are views showing gas passages on the front surface side and rear surface side of a fuel cell separator according to a fifth embodiment of the fuel cell separator to which this invention is applied. In this embodiment, the passage form differs between the front surface side and rear surface side of the separator. Identical constitutional elements to those shown in FIGS. 1, 2 have been allocated identical reference numerals, and description thereof has been omitted for the sake of simplicity.

In the fuel cell separator 1 shown in FIGS. 7A, 7B, the distribution portion 10 and merging portion 12, constituted by straight passages which are long in the passage direction and having similar ribs to those of the first embodiment or second embodiment, face the end portions of the ribs 21 in the main passage portion 11 via the gaps 13, 14. A serpentine passage 9 which meanders from the manifold inlet 3 toward the manifold outlet 6 is formed on the rear surface portion of the separator 1.

Since the serpentine passage 9 takes a meandering form, a plurality of ribs 26 is arranged continuously in the passage direction from the manifold inlet 3 to the manifold outlet 6, and no gaps are provided in the ribs 26 in the passage direction. Hence, although the gaps 13, 14 for the purpose of re-distribution and re-merging exist between the main passage portion 11 and the distribution portion 10 or merging portion 12 on the front surface side, all of the corresponding length direction positions on the rear surface side are formed with the ribs 26 of the serpentine passage 9.

In the separator 1 described above, the gaps 13, 14 are provided between the ribs 20, 22 constituting the distribution portion 10 and merging portion 12 and the ribs 21 constituting the main passage portion 11, and the ribs 26 of the serpentine passage 9 are provided on the rear surface side. As a result, at least one of the ribs 26 which are resistant to bending exists in any cross-section that intersects the length direction of the separator 1, and hence the strength of the separator 1 can be increased.

In the fifth embodiment, the following effect is achieved in addition to the effect (a) of the first embodiment.

(g) The passage disposed on the rear surface of the separator 1 is formed as the serpentine passage 9 which meanders over the surface from the inlet manifold 3 to the outlet manifold 6, and therefore, although the gaps 13, 14 are provided between the ribs 20, 22 constituting the distribution portion 10 and merging portion 12 and the ribs 21 constituting the main passage portion 11 in the passage 8 on the front surface, the ribs 26 of the serpentine passage 9 are provided on the rear surface side. As a result, at least one of the ribs 26 which are resistant to bending exists in any cross-section that intersects the length direction of the separator 1, and hence the strength of the separator 1 can be increased.

### Sixth and Seventh Embodiments

The sixth and seventh embodiments have common features, and will therefore be described together.

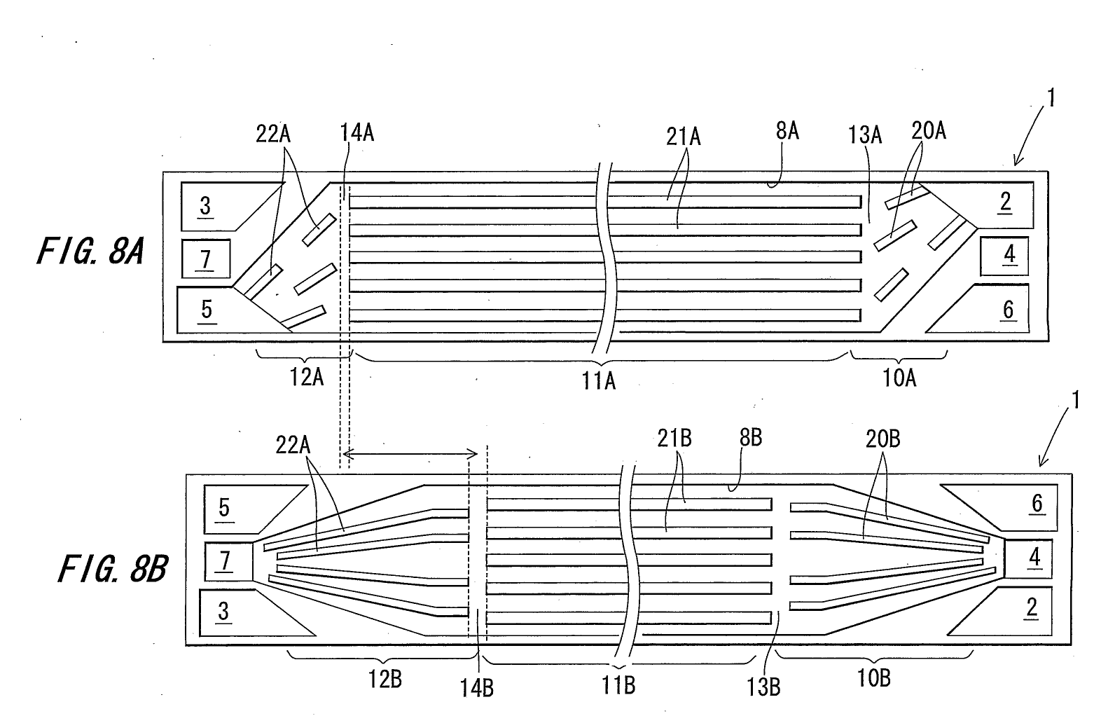

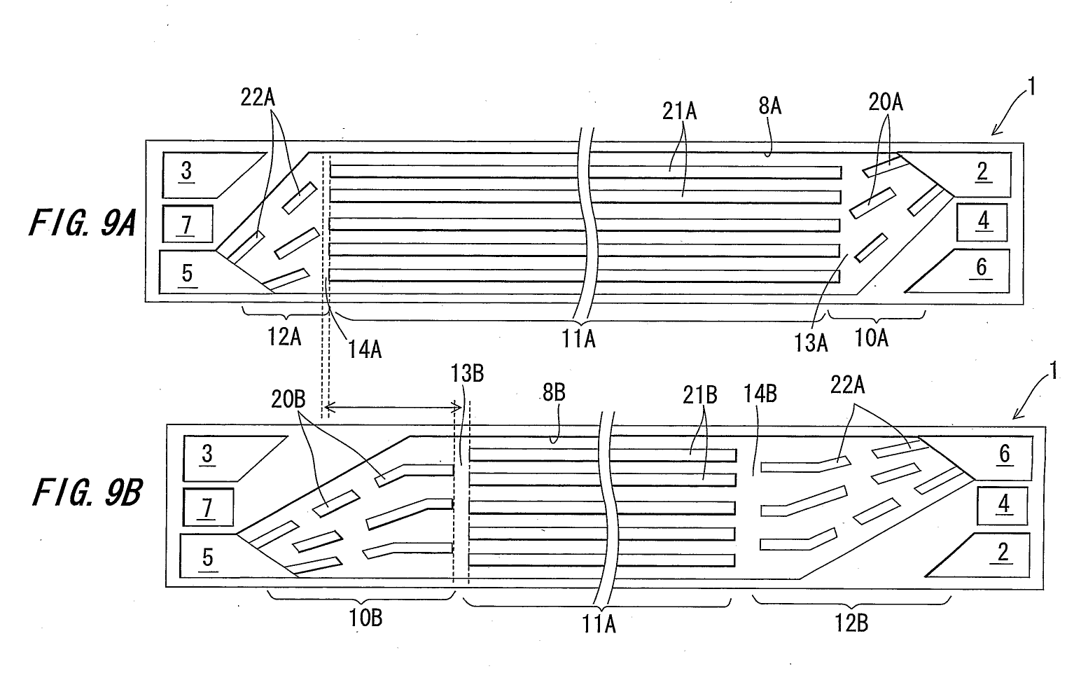

FIGS. 8A and 8B are views showing gas passages on the front surface side and rear surface side of a fuel cell separator according to the sixth embodiment, and FIGS. 9A and 9B are views showing gas passages on the front surface side and rear surface side of a fuel cell separator according to the seventh embodiment.

In the sixth and seventh embodiments, the separator length direction positions of the gaps between the ribs of the distribution portion and merging portion and the ribs of the main passage portion are offset by varying the length of the main passage on the front surface side and the length of the main passage on the rear surface side. Identical constitutions to those in FIGS. 1 and 2 have been allocated identical reference numerals, and description thereof has been omitted for the sake of simplicity.

In the fuel cell separator of the sixth embodiment, shown in FIGS. 8A, 8B, both the front surface side and rear surface side of the separator 1 are formed such that the distribution portions 10A, 10B and merging portions 12A, 12B, constituted by straight passages which are long in the passage direction and having similar ribs to those of the first and second embodiments, face the end portions of the ribs 21A, 21B in the main passage portions 11A, 11B via the gaps 13A, 13B, 14A, 14B.

Further, the ribs 21A constituting the main passage portion 11A on the front surface side are longer than the ribs 21B constituting the main passage portion 11B on the rear surface side. Hence, the gaps 13A, 14A on the front surface side between the ribs 20A, 22A constituting the distribution portion 10A and merging portion 12A and the ribs 21A constituting the main passage portion 11A are closer to the inlet and outlet manifolds 4, 7 than the gaps 13B, 14B on the rear surface side between the ribs 20B, 22B constituting the distribution portion 10B and merging portion 12B and the ribs 21B constituting the main passage portion 11B. As a result, the separator length direction positions of the gaps 13A, 14A on the front surface side and the gaps 13B, 14B on the rear surface side are different.

In this separator 1, by introducing a cooling medium into the passage 8B on the rear surface side and introducing a fuel gas such as hydrogen or an oxidant gas such as air (oxygen) into the passage 8A on the front surface side, the main reactant gas passage increases in width. Thus, the ratio of the catalyst electrode surface area to the volume of the stack can be increased, and the output density of the fuel cell stack can be raised.

As shown in FIGS. 9A, 9B, when a fuel gas such as hydrogen is introduced into the passage 8A on the front surface side and an oxidant gas is introduced into the passage 8B on the rear surface side, the main passage 11B of the oxidant gas passage 8B on the rear surface can be made shorter than the fuel gas passage 8A. By reducing the length of the oxidant gas passage 8B in this manner, loss in the passage can be reduced, the load placed on a compressor for delivering the oxidant gas (air) can be reduced, and as a result, the fuel consumption required to run the vehicle can be reduced.

As the flow rate and gas density at the point of distribution into the main passage 11B increases, the effect of inertia increases, and distribution becomes more difficult. In other words, under typical fuel cell operating conditions, the density and flow rate of the oxidant gas are higher than those of the fuel gas. Therefore, by reducing the length of the main fuel gas passage 11B, into which it is difficult to achieve even distribution, or in other words by widening the distribution portion 10B and merging portion 12B, even distribution into the main passage 11B can be achieved.

In the sixth embodiment, the following effect can be achieved in addition to the effect (a) of the first embodiment and the effects (d), (e) of the second embodiment.

(h) The length of the main passage portions 11A, 11B in the passages 8A, 8B formed on the two surfaces of the separator 1 is varied such that one surface side (the front surface side, 11A) is longer than the other surface side (the rear surface side, 11B). A cooling medium is then introduced into the passage 8B on the rear surface side, while a fuel gas such as hydrogen or an oxidant gas such as air (oxygen) is introduced into the passage 8A on the front surface side.

In so doing, the gaps 13A, 13B, 14A, 14B for causing re-distribution and re-merging between the main passage portion 11 and the distribution portion 10 and merging portion 12 are offset between the front and rear surfaces sides, and as a result, flexural strength of the separator 1 can be improved. Moreover, the reactant gas main passage 11A can be made wider, the ratio of the catalyst electrode surface area to the volume of the stack can be increased, and hence the output density of the fuel cell stack can be increased.

In the seventh embodiment, the following effect can be achieved in addition to the effect (a) of the first embodiment and the effects (d), (e) of the second embodiment.

(i) The length of the main passage portions 11A, 11B of the passages 8A, 8B formed on the two surfaces of the separator 1 is varied such that one surface side (the front surface side, 11A) is longer than the other surface side (the rear surface side, 11B). A fuel gas such as hydrogen is then introduced into the passage 8A on the front surface side, while an oxidant gas is introduced into the passage 8B on the rear surface side.

In so doing, the gaps 13A, 13B, 14A, 14B for re-distribution and re-merging between the main passage portions 11A, 11B and the distribution portions 10A, 10B and merging portions 12A, 12B are offset between the front and rear surfaces sides, and as a result, flexural strength of the separator 1 can be improved. Moreover, although the flow rate and gas density at the point of distribution into the main passage 11B increases, the effect of inertia increases and distribution becomes more difficult, according to the seventh embodiment, the oxidant gas can be distribute evenly by reducing the length of the main oxidant gas passage 11B or in other words by widening the distribution portion 10B and merging portion 12B.

The entire contents of Japanese Patent Application P2004-364335 (filed Dec. 16, 2004) are incorporated herein by reference.

Although the invention has been described above by reference to a certain embodiment of the invention, the invention is not limited to the embodiment described above. Modifications and variations of the embodiments described above will occur to those skilled in the art, in the light of the above teachings. The scope of the invention is defined with reference to the following claims.

### INDUSTRIAL APPLICABILITY

This invention is useful for securing the strength of a fuel cell separator while maintaining reactant gas re-distribution and re-merging functions.

1. A fuel cell separator which supports an electrolyte membrane from either side via an electrode catalyst to form a polymer electrolyte fuel cell, comprising on a front surface thereof a fluid passage which supplies a fluid to a surface of the electrolyte membrane,
wherein the fluid passage of the separator comprises:
a main passage portion having a greater width than an inlet manifold and an outlet manifold, and comprising a first rib which divides the main passage portion into a plurality of passages; and
a distribution portion and a merging portion disposed between the main passage portion and the inlet manifold or outlet manifold, comprising a second rib which divides the distribution portion and merging portion into a plurality of passages, and a gap provided between an end portion of the second rib and the first rib for the purpose of re-distribution or re-merging, and
either at least one of the first and second ribs exists in at least one location in a length direction position of the separator in which the gap exists, or a third rib for dividing a fluid passage formed on a rear surface of the separator exists in at least one location in the length direction position of the separator in which the gap exists.

2. The fuel cell separator as defined in claim 1, wherein the separator length direction positions of the gap is offset from the adjacent gap.

3. The fuel cell separator as defined in claim 1, wherein the separator length direction position of the gap is offset from the gap provided for the purpose of re-distribution or re-merging in the fluid passage disposed on the rear surface.

4. The fuel cell separator as defined in claim 1, wherein at least one of the passages of the distribution portion and the merging portion disposed on at least one surface of the separator is a straight passage divided by the second rib.

5. The fuel cell separator as defined in claim 1, wherein the passage disposed on the other surface of the separator is a passage which meanders within the surface from the inlet manifold toward the outlet manifold.

6. The fuel cell separator as defined in claim 1, wherein, of the passages formed on the two surfaces of the separator, the passages of the main passage portion are parallel.

7. The fuel cell separator as defined in claim 1, wherein the length of the main passage portion formed on one surface side of the separator is greater than the length of the main passage portion formed on the other surface side, and
a cooling medium is introduced into the fluid passage on the other surface side, while a fuel gas or an oxidant gas is introduced into the fluid passage on the one surface side.

8. The fuel cell separator as defined in claim 1, wherein the length of the main passage portion formed on one surface side of the separator is greater than the length of the main passage portion formed on the other surface side, and
a fuel gas is introduced into the fluid passage on the one surface side, while an oxidant gas is introduced into the fluid passage on the other surface side.
